(19) United States
(12) Patent Application Publication
(10) Pub. No.: US 2017/0163597 A1
(43) Pub. Date: Jun. 8, 2017

(54) IP ADDRESS OF WIRELESS CLIENT DEVICE

(71) Applicant: Aruba Networks, Inc., Sunnyvale, CA (US)

(72) Inventors: Varaprasad Amerneni, Bangalore Karnataka (IN); Deepthi Sosale Venu, Bangalore Karnataka (IN); Abhishek Dwivedi, Bangalore Karnataka (IN); Amol Dhananjay Kelkar, Bangalore Karnataka (IN)

(21) Appl. No.: 15/294,824

(22) Filed: Oct. 17, 2016

(30) Foreign Application Priority Data
Dec. 5, 2015 (IN) 6831/CHE/2015

(51) Int. Cl. H04L 29/12

(52) U.S. Cl. CPC H04L 61/2076; H04L 61/2061; H04W 80/04

(57) ABSTRACT

In some examples, a message is received from a wireless client device. The message includes an IP address of the wireless client device. It is determined whether an IP address offered by a DHCP server is the same as an IP address in a message received from the wireless client device. If the IP addresses are not the same, then a force renew DHCP message is sent to the wireless client device.

### BACKGROUND

In a wireless local area network (WLAN), wireless client devices may wirelessly connect to an access point (AP). The AP may allow the wireless client devices to communicate with other devices in the WLAN, or with other networks. For instance the AP may be connected to a wired network thereby allowing client devices to connect via the AP to a local area network or to the Internet. A plurality of APs may be managed by a controller. Roaming refers to a client device moving from a first AP to a second AP. The roaming may be between APs managed by the same controller, or between two APs managed by different controllers.

Dynamic Host Configuration Protocol (DHCP) is a protocol by which a client device may be dynamically assigned with an internet protocol (IP) address. A DHCP session may include a plurality of messages sent between a client device and a DHCP server, by which the client device is assigned an IP address from a pool of IP addresses held by the DHCP server.

### BRIEF DESCRIPTION OF THE DRAWINGS

Examples will now be described, by way of non-limiting example only, with reference to the accompanying drawings, in which:

FIG. 1 is a network diagram showing an example of a wireless client device roaming between access points according to the present disclosure;

FIG. 2 is a flow diagram showing an example method carried out by a controller according to the present disclosure;

FIG. 3 is a flow diagram showing an example method carried out by a controller according to the present disclosure;

FIG. 4A is an example datapath route cache table according to the present disclosure;

FIG. 4B is an example user table according to the present disclosure;

FIG. 5 is an example structure of a controller according to the present disclosure;

FIG. 6 is an example structure of a controller according to the present disclosure; and

FIG. 7 is an example structure of a fat access point according to the present disclosure.

### DETAILED DESCRIPTION

In the following description the terms “a ” and “an” are used to denote the presence of one or more of a particular element.

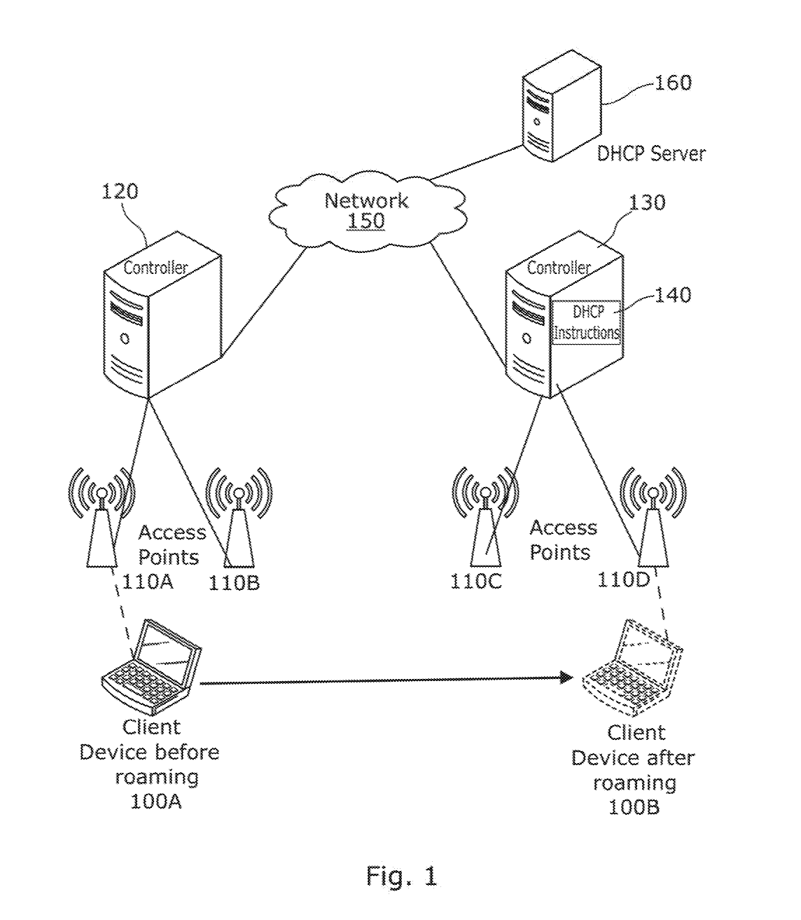

FIG. 1 shows an example wireless local area network (WLAN). The WLAN includes a plurality of access points (APs). A first set of APs 110A, 110B are managed by a first controller 120 and a second set of APs 110C, 110D are managed by a second controller 130. The controllers 120, 130 connect to a wired network 150 through which a dynamic host configuration protocol (DHCP) server 160 may be reached. The wired network 150 may also provide access to other resources, such as a local area network (LAN) of an enterprise or school and to wide area networks (WANs) such as the Internet. Wireless client devices may connect to the WLAN via the APs.

The controllers 120, 130 are responsible for setting and enforcing security, quality of service and other policies for the wireless client devices and facilitating roaming between APs. In some cases the controllers may also monitor the wireless environment and load on each AP. The APs may be directly connected to a controller by a wired connection, such as Ethernet as shown in FIG. 1. In other cases the APs may link to a controller via one or more intermediate devices, by using a management tunnel such as Control and Provisioning of Wireless Access Points (CAPWAP), or through a wireless connection. Typically a wireless client device will send a request to join an AP, undergo an authentication process and then be associated with the AP after completing the authentication. When a client device associates with an AP, the controller managing the AP may add an entry in its user table including details of the wireless client device and the AP and any associated security or quality of service (QOS) profiles.

Each AP is responsible for wirelessly sending and receiving messages to and from the wireless client devices which it is associated with. In the illustrated example, the controllers 120, 130 act as switches connecting the APs to the wired network 150. In other examples, there may be separate switches connecting the APs to the wired network and the controllers may connect to the APs via the separate switches. The wired network may include at least one virtual local area network (VLAN) to limit the broadcast domains. The controllers 120, 130 may be on the same (VLAN) or separate VLANs.

Roaming is a process by which a client device switches to a new AP. For example, this may include associating with a new AP and terminating the association with the old AP. This typically occurs when a mobile wireless client device moves further away from a first AP and closer to a second AP. Roaming may be initiated by a wireless client device, for instance in response to the client device determining that the strength of a wireless signal from the AP it was originally associated with has dropped below a certain level, or that the wireless signal fromanother AP is stronger. FIG. 1 shows an example of a wireless client device roaming between AP 100A and AP 110D. Reference numeral 100A denotes the wireless client device before roaming, when it is associated with AP 110A, and reference numeral 100B denotes the wireless client device after roaming, when it is associated with AP 110D.

If a wireless client devices roams between APs managed by the same controller, then the controller may simply update its user table to record that the wireless client device is now associated with a new AP. However, in the case of a wireless client device roaming between APs managed by different controllers, the first controller may send information relating to the client device to the second controller. For instance the user table entry or certain information from the user table entry may be copied over to the second controller. The second controller may update the copied user table entry to adjust the security or QOS profiles if necessary and to record the new AP which the wireless client device is associated with.

When a wireless client device first joins a WLAN it may initiate a dynamic host configuration protocol (DHCP) session to obtain a dynamically assigned IP address. The controller managing the AP to which the client is associated, may snoop the DHCP session. Snooping a DHCP session involves reading one or more DHCP messages so as to learn the IP address which is assigned to the wireless client device. The controller may then add the snooped IP address to the user table.

Many controllers have an enforce DHCP mode in which the controller insists that a wireless client device obtains a dynamically assigned IP address, before it is allowed access to the WLAN. That is the controller will block, or instruct its APs to block, wireless client devices for which the controller has not snooped a DHCP message. This prevents client devices from joining the WLAN with statically configured IP addresses, or IP addresses obtained from elsewhere. The enforce DHCP mode may be desirable for various reasons including to avoid duplication of IP addresses in the network and to enhance network security.

A difficulty arises when a wireless client device joins an AP managed by a first controller and obtains an IP address through a DHCP session, but then roams to another AP which is managed by a second controller. The second controller may have no record of the previous DHCP session and therefore, if the second controller is in enforce DHCP mode, it may block the wireless client device from accessing the WLAN. The controller may send a de-authentication request to the wireless client device, forcing it to de-associate and re-associate with the AP. However, as many client devices cache an IP address after a DHCP session and continue to use it thereafter, this de-association and re-association process may not be enough to cause a wireless client device to obtain a new IP address through a new DHCP session.

Accordingly, the present disclosure proposes that the controller communicates with a DHCP server on behalf of the wireless client device and determines whether the offered IP address is the same as the IP address currently used by the wireless client device. If the IP addresses are not the same, then the controller may send a force renew DHCP message to the wireless client device, so as to cause the wireless client device to initiate a DHCP session to obtain a new IP address.

This method is convenient as it is driven by the controller and the user does not have to manually release the IP address and manually start a new DHCP session. Furthermore, by communicating with a DHCP server on behalf of the client device and checking if a received IP address is the same as the existing IP address, the wireless client device is not requested to renew its IP address unless it needs to. If the wireless client device already has an IP address which is the same as the offered IP address, it is not instructed to initiate a new DHCP session. Therefore this method saves time compared to completing a full DHCP session each time a client device roams between APs managed by different controllers.

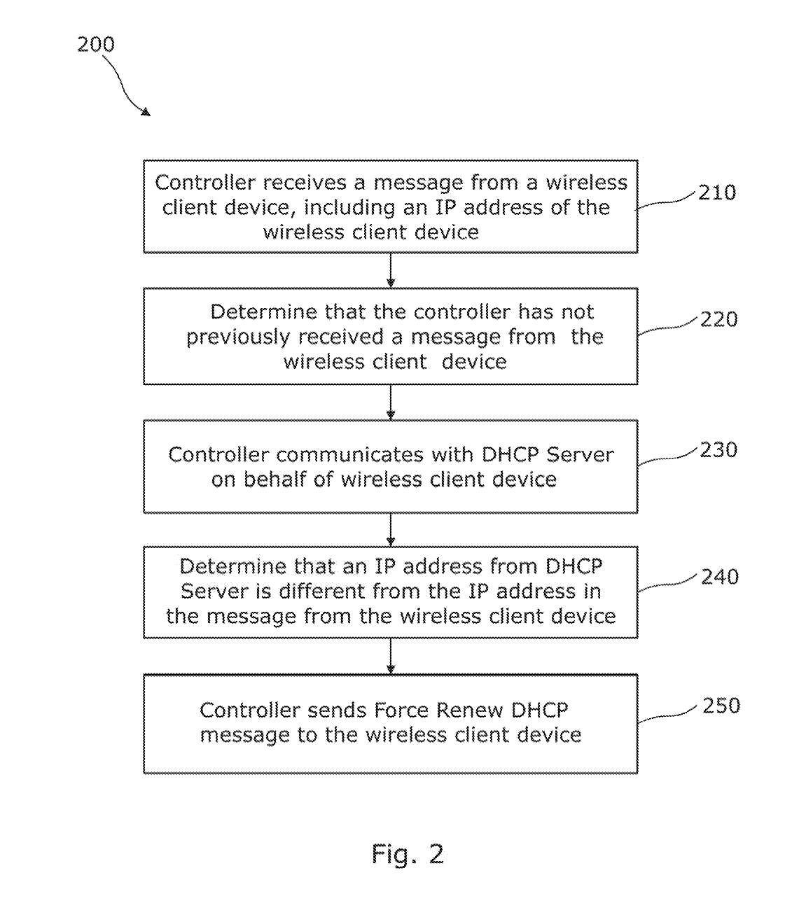

FIG. 2 is a flow diagram showing an example method implemented by the controller.

At block 210 the controller receives a message from a wireless client device. The message includes an IP address of the wireless client device. For instance, the IP address of the wireless client device may be in a source IP address field of the message.

The message may be a message which was sent from a wireless client device to an AP associated with the wireless client device, and forwarded by the AP to the controller. The AP may be directly connected to the controller as shown in FIG. 1, or may be connected via an intermediate device, or several intermediate devices.

At block 220 the controller determines whether or not it has previously received a message from the wireless client device. For example, the controller may determine this by referring to a memory of the controller.

The controller may for instance check if an identifier of the wireless client device is stored in a memory of the controller. In one example the controller searches a datapath route cache table to determine whether there is an entry in the table relating to the wireless client device.

At block 230 in response to determining that the controller has not previously received a message from the wireless client device, the controller communicates with a DHCP server on behalf of the wireless client device.

This communication may be involve the controller determining what IP address a DHCP server would offer to the wireless client device. For instance, the controller may send a DHCP discover message on behalf of the wireless client and receive a DHCP offer from a DHCP server in response to the DHCP discover message.

At block 240 the controller determines whether an IP address received from the DHCP server in block 230 is the same as the IP address of the wireless client device in the message received in block 210.

If the IP addresses are the same, then this indicates that the wireless client device is using a dynamically assigned IP address appropriate for the new controller and may continue to do so. The controller may allow the wireless client device to access the WLAN and/or communicate with the wired network 150 and the Internet etc. However, if the IP addresses are different, this suggests that the wireless client device is using a statically assigned IP address, or an address which is not appropriate now it has roamed to the new controller. Therefore the wireless client device should obtain a new IP address.

At block 250, in response to determining that the IP address received from the DHCP server is not the same as the IP address of the wireless client device in block 210, the controller sends a force renew DHCP message to the wireless client device. The force renew DHCP message may be sent via the AP which the wireless client device is associated with.

The force renew DHCP message instructs the wireless client device to obtain a new IP address. For instance, the wireless client device may obtain a new IP address by initiating a new DHCP session. The wireless client device may, for example, initiate a new DHCP session by sending a DHCP discover message. The controller may snoop the DHCP session in order to determine the new IP address assigned to the wireless client device, record the new IP address in its memory and thereafter allow the wireless client device access to the WLAN and wired network etc.

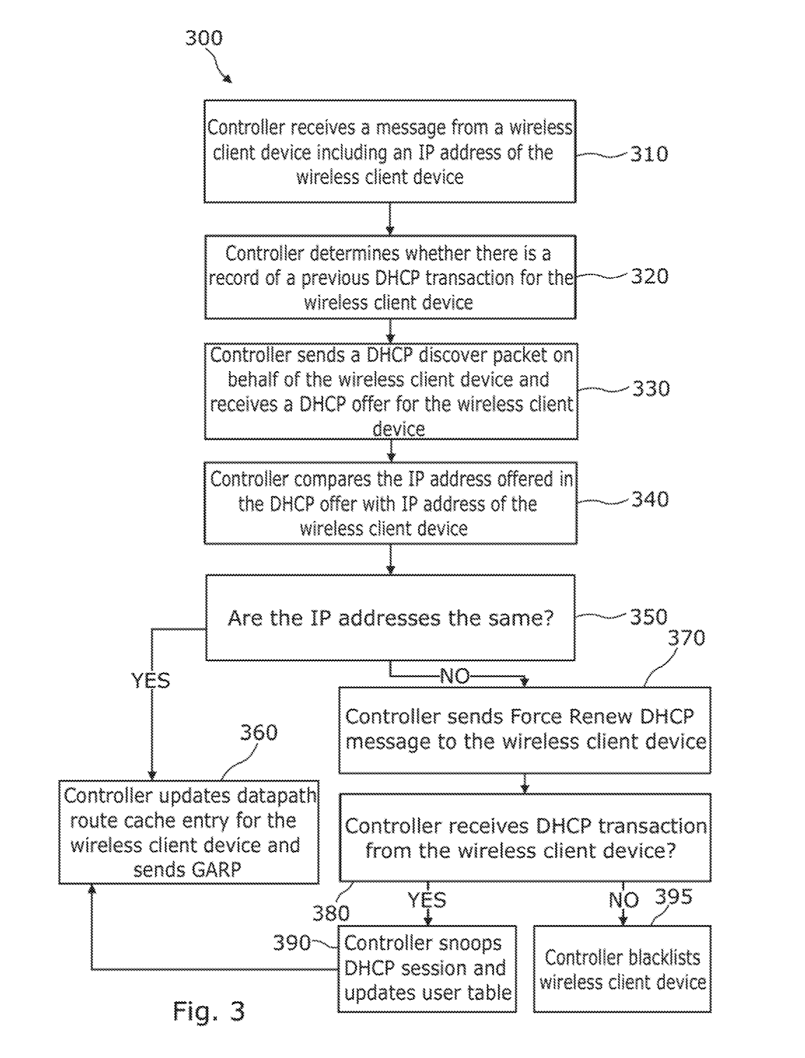

FIG. 3 shows another example method of managing an IP address by a controller in more detail. The method may, for example, be implemented by a controller which is in enforce DHCP mode.

Typically, if a client device does not have an IP address, then its first action after associating with an AP will be to start a DHCP session in order to obtain an IP address. A controller may snoop a DHCP session in order to obtain the IP address and update its memory to indicate that it has DHCP snooped the wireless client device. On receiving subsequent messages from the wireless client device, the controller in enforce DHCP mode may recognize that it has already DHCP snooped the wireless client device and allow it to access the WLAN.

However, in other cases a wireless client device may already have an IP address before it associates with the AP. For instance, the wireless client device may have obtained an IP address through a DHCP session carried out before roaming to the current AP and controller, or may have a statically configured IP address. Another example is if the wireless client device previously acquired an IP address on an unrelated network, such as a user's home WLAN, and the client device remembers this IP address and attempts to use it when connecting to a new WLAN, such as an office WLAN which uses a different DHCP server. In these cases, as the controller has no record of a previous DHCP transaction for the wireless client device, the DHCP enforce mode may prevent the wireless client device from accessing the WLAN. The methods of FIGS. 2 and 3 help to address this.

At block 310 of FIG. 3, the controller receives a message from a wireless client device including an IP address of the wireless client device. For instance, the IP address of the wireless client device may be in a source IP field of the message.

As mentioned above, the IP address may be an address which the wireless client device obtained through a DHCP sessions initiated after joining an AP managed by the current controller. In that case, the controller will already have snooped the DHCP address. However, in other cases the IP address may have been obtained prior to joining an AP managed by the current controller.

For instance, with reference to FIG. 1, the wireless client device may associate with AP 110A and obtain an IP address through a DHCP session with the DHCP server 160. The first controller 120 manages the AP110A and may snoop the DHCP session. However, if the wireless client device subsequently roams within the WLAN to the AP 110D managed by the second controller 130, then the wireless client device will still have the IP address, but the second controller 130 may have no record of that DHCP transaction. The following block 320 may detect when this is the case.

At block 320, the controller determines whether there is any record of a previous DHCP transaction for the wireless client device. For example, the controller may check its memory for an entry indicating the wireless client device has previously completed a DHCP session. For example, the controller may check for a record indicating that it has snooped a DHCP session of the wireless client device.

In one example, the controller may do this by searching a datapath route cache table for an entry relating to the wireless client device. A datapath route cache table is a table including entries for each wireless client device that the controller is aware of. The controller may use the datapath route cache table to determine how to handle messages from a particular wireless client device. An entry in the datapath route cache table may be created after a wireless client device associates with an AP managed by the controller.

The datapath route cache table may include at least an identifier of the wireless client device, such as an IP address of the wireless client device, and an indicator, such as a flag, indicating whether or not the controller has snooped a DHCP session of the wireless client device. Based on this indicator the controller may determine whether or not it has a record of a DHCP transaction for the wireless client device.

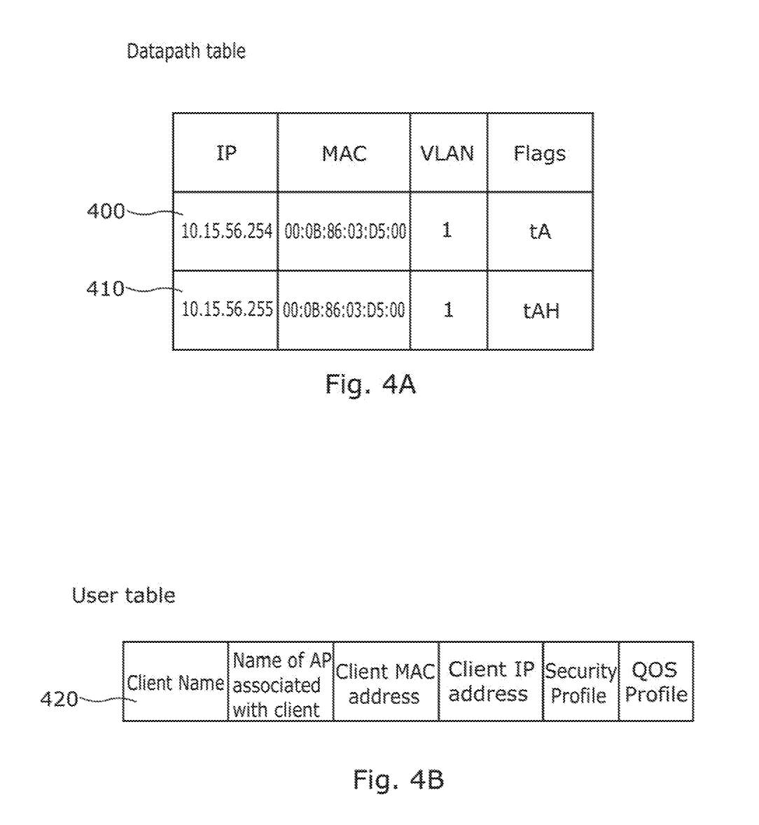

An example datapath route cache table is shown in FIG. 4A. In this example, each entry includes the following: an IP address of the wireless client device to which the entry relates, a media access control (MAC) address, a VLAN and flags. The MAC address may be, but is not necessarily, a MAC address of the wireless client device. In other examples, the MAC address in the table entry may be a MAC address of the AP which the wireless client device is associated with, or a MAC address of an intermediate device. The VLAN indicates a VLAN which the wireless client device belongs to. The table entry may include any number of flags. For example, it may include no flags, one flag or a plurality of flags. Each flag relates to a property, or policy, of the wireless client device. A flag may indicate how messages from the wireless client device are to be handled. On receiving a message from a wireless client device, the controller may refer to the datapath route cache table in order to determine how the message is to be handled.

One type of flag is a H-DHCP snooped flag. When this flag is present it indicates that the controller has previously snooped a DHCP session of the wireless client device. Various other flags may be possible depending upon the design of the controller. Examples of possible flags include: L—Local, P—Permanent, T—Tunnel, I—IPsec, t—trusted, A—ARP, D—Drop, R—Routed across vlan, O—Temporary, N—INactive, H—DHCP snooped. For instance, an L flag indicates the wireless client device is a local device, a P flag indicates a permanent entry which should not be deleted, a T flag indicates that messages from the wireless client device are to be routed through a tunnel, an I flag indicates that IPsec is to be applied to communicatons with the wireless client device, a ‘t flag’ indicates that the wireless client device is a trusted device, an A flag indicates that the entry was learned by an ARP packet, a D flag indicates that messages from the wireless client device are to be dropped, and an R flag indicates that a message from the wireless client device is to be routed across a VLAN, an O flag indicates a temporary entry, and an N flag indicate an inactive entry which may be flushed or deleted on expiry of a timer.

When the controller is in enforce DHCP mode it will not allow the wireless client device access to the WLAN or wired network if the table entry for the wireless client device does not include an H flag.

The example datapath route cache table in FIG. 4A shows a first example entry in which the IP address is 10.15.56.254, the MAC address is 00:0B:86:03:D5:00, the VLAN 1 and the flags t and A are present. As there is no H flag, this indicates that the controller has not previously DHCP snooped the wireless client device with IP address 10.15.56.254. Therefore when the controller is in enforce DHCP mode it will not allow a wireless client device with this EP address to access the WLAN or wired network. A second entry includes the IP address is 10.15.56.255, the MAC address is 00:0B:86:03:D5:00, the VLAN 1 and the flags t, A and H are present. The H flag indicates that the controller has DHCP snooped the wireless client device. Therefore when the DHCP enforce mode is on, based on the datapath route cache table, the controller will allow a wireless client device with IP address 10.15.56.255 to access the WLAN or wired network etc.

At block 330, in response to determining that there is no record of a previous DHCP transaction for the wireless client device, the controller sends a DCHP discover message on behalf of the wireless client device and receives a DHCP offer for the wireless client device. For instance the controller may unicast or broadcast a DHCP discover on the VLAN of the wireless client device and receive a DCHP offer sent by the DHCP server in response to the DHCP discover message.

At blocks 340 and 350 the controller compares the IP address received in the DCHP offer with the IP address currently held by the wireless client device. The ‘IP address currently held by the wireless client device’ is the IP address of the wireless client device as indicated in the message received from the wireless client device in block 310.

If the IP addresses are the same, then the wireless client device is allowed to continue using its IP address and to access the WLAN and or the wired network. Thus, in response to determining that the IP addresses are the same, at block 360 the controller updates the datapath cache route entry for the wireless client device to indicate that it has a record of a DHCP transaction for the wireless client device. For example, the controller may update the entry to add a flag indicating that it has DHCP snooped the wireless client device. Other fields in the datapath cache route entry for the wireless client device may remain unchanged.

The controller may further broadcast a gratuitous address resolution protocol (GARP) message. A GARP message is an address resolution protocol (ARP) message where the source IP address and destination. IP address are both set to the IP address of the wireless client device. The destination MAC address may be set as a broadcast address, for example ff:ff:ff:ff:ff:ff. The GARP has the effect of updating the forwarding tables of neighboring devices that receive the broadcast, so that they are aware of the IP address of the wireless client device. Further, if any device receiving the GARP has the same IP address, it may raise an alert indicating that there is a duplicate IP address.

Referring back to block 350, if it is determined that the IP addresses are not the same, then the method proceeds to block 370 where the controller sends a force renew DHCP message to the wireless client device. The force renew DCHP message instructs the wireless client device to obtain a new IP address by initiating a new DHCP session.

In most cases, this should cause the wireless client device to initiate a DHCP session. For instance if the wireless client device was using a cached IP address from a previous DHCP session on the WLAN or elsewhere, then the force renew DHCP message should prompt it to start a new DHCP session by broadcasting a DCHP discover message on its VLAN. However, if the wireless client device is stuck in a static IP mode, or for some reason is unable to start a DHCP session, then it may not respond to the force renew DHCP message.

At block 380 the controller checks whether it has received a DHCP transaction, such as a DHCP discover or other message of a DHCP session from the wireless client device, in response to the force renew DHCP message. If yes, then at 390 the controller snoops the DHCP session and updates the user table entry for the wireless client device to reflect the new IP address.

The user table entry may be stored in a memory of the controller and includes the IP address of the wireless client device and some basic information relating to the wireless client device, such as a security profile and/or quality of service (QOS) profile. An example of a user table entry is shown in FIG. 4B. Each entry may include a client name which is a name of the wireless client device, a name of the AP associated with the wireless client device, a MAC address of the wireless client device, an IP address of the wireless client device, a security profile of the wireless client device and a QOS profile for the wireless client device.

The controller then proceeds to block 360 to update the datapath route cache entry to indicate that the wireless client device has been DHCP snooped, and sends a GARP to inform other devices of the new IP address of the wireless client device.

However, if the wireless client device does not respond to theforce renew DHCP message and does not successfully obtain a new IP address, then the controller may block the wireless client device at block 395. This may be referred to as blacklisting the wireless client device and may for example be achieved by adding a flag, such as a D-drop flag to the datapath route cache table entry for the wireless client device. The controller may indicate a reason for blacklisting the wireless client device, such as “static IP address”. The controller may wait for a predetermined period of time and/or send a predetermined number of force renew DHCP messages without receiving a response, before blacklisting the wireless client device.

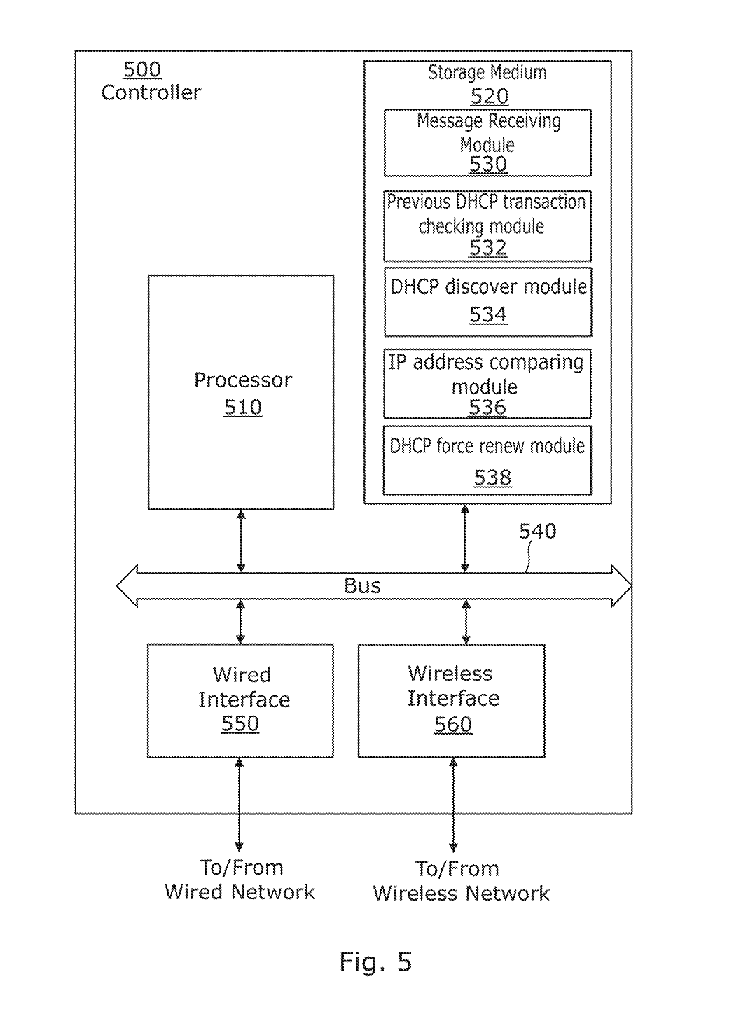

FIG. 5 shows an example of a controller 500 according to the present disclosure. The controller 500 may for example be a controller such as the first controller 120, or the second 130 controller shown in FIG. 1. The controller may include a processor 510 and a non-transitory machine readable storage medium 520. The non-transitory machine readable storage medium may for example be a random access memory, flash memory, disk drive etc., or any combination thereof. The storage medium 520 stores modules of machine readable instructions which are executable by the processor 510. The processor is able to read and write to the storage medium via a communication medium such as a bus 540. The controller may also include one, or both of, a wired interface 550 to connect with a wired network and a wireless interface 560 to connect with other devices wirelessly.

The modules of machine readable instructions may be executed by the processor to implement the methods of FIG. 2 or 3. The modules may include a message receiving module 530 to receive a message from a wireless client device. The message may be received by the wired or wireless interface of the controller and may be sent directly, or indirectly, via an AP, or over a CAPWAP tunnel or similar. The instructions further include a Previous DHCP transaction checking module 532 to check whether the controller has a record of a previous DHCP transaction for the wireless client device, for example as described in block 320 of FIG. 3. There is a DHCP discover module 534 to send a DHCP discover packet on behalf of the wireless client device and receive a DHCP offer as is as described for example in block 230 of FIG. 2, or block 330 of FIG. 3. There is an IP address comparing module 536 to compare an IP address received from a DHCP server with the IP address of a wireless client device, as described in block 240 of FIG. 2 and blocks 340 and 350 of FIG. 3. There is a DHCP force renew module 538 to send a force renew DHCP message to a wireless client device as described in block 250 of FIG. 2 and block 370 of FIG. 3. There may be further modules (not shown) to carry out various other tasks described in FIGS. 2 and 3.

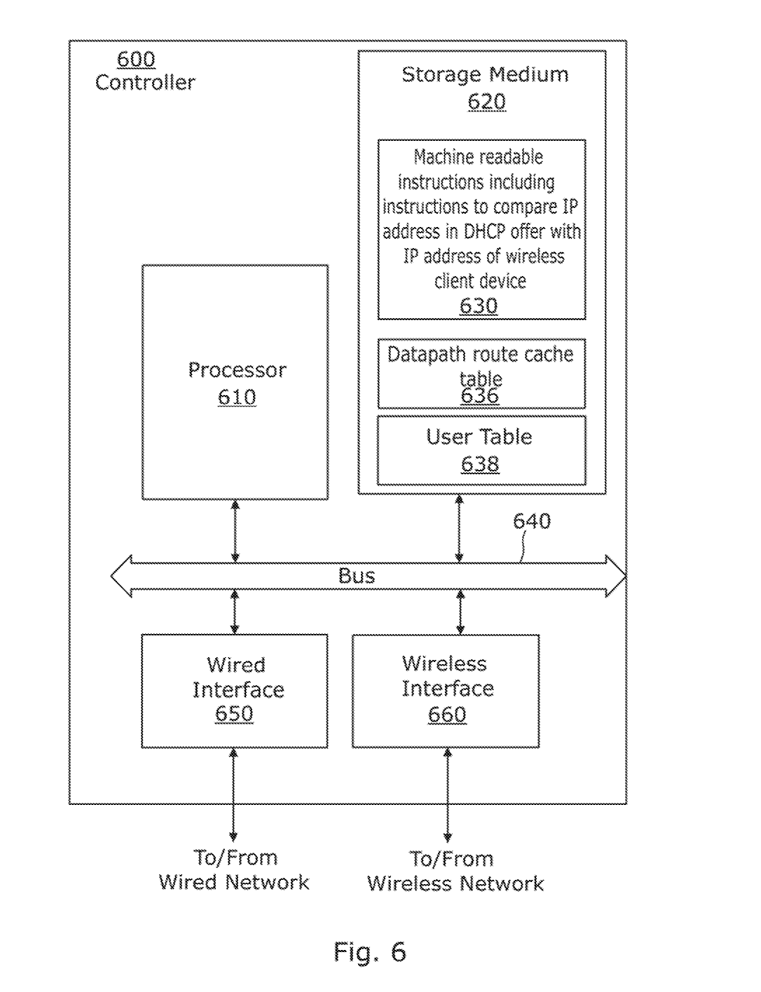

FIG. 6 shows another example of a controller 600 according to the present disclosure. This is similar to the controller of FIG. 5. It includes a processor 610, non-transitory machine readable storage medium 620, bus 640, wired interface 650 and wireless interface 660 which are the same as respective components described in FIG. 5. The contents of the storage medium 620 are shown differently however. Whereas FIG. 5 shows a set of functional modules which may be implemented by machine readable instructions, FIG. 6 shows the storage medium 620 as storing a set of machine readable instructions 630 as well as a datapath route cache table 636 and a user table 638. The datapath route cache table 636 may be the same as described previously in this disclosure, for example as shown in FIG. 4A. The user table 638 may be the same as described previously in this disclosure, for example as shown in FIG. 4B. The machine readable instructions 630 may include instructions to carry out any of the processes described herein, for example any of the processes described in FIGS. 2 and 3. The instructions include at least instructions to compare an IP address in a DHCP offer with an IP address of the wireless client device, for example as described in block 240 of FIG. 2 and block 340 of FIG. 3.

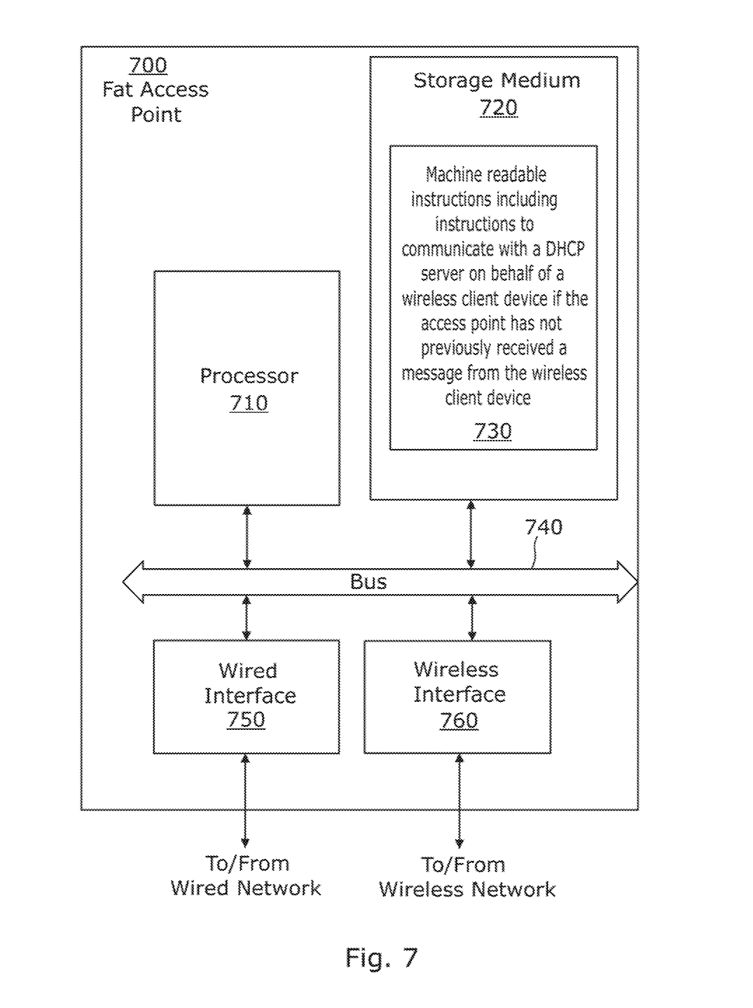

FIG. 7 shows an example of a fat access point 700 that may implement a method according to the present disclosure. A fat access point is an access point which carries out some management functions independently, rather than relying on a controller. In effect many functions of the controller, including those described in FIGS. 1 to 6, may be carried out by the fat access point on its own behalf. The fat access point includes a processor 710, non-transitory machine readable storage medium 720 and an internal communication medium, such as a bus 740, to allow the processor to access the storage medium. The fat access point further includes a wireless interlace 760 for sending and receiving wireless messages and may also include a wired interface 750.

The storage medium 720 stores machine readable instructions that are executable by a processor to implement a method according to the present disclosure. For example the instructions may be instructions to carry out the method of FIG. 2 or FIG. 3, but in which actions carried out by the fat access point instead of the controller. Thus, the instructions may include instructions for the access point to communicate with a DHCP server on behalf of a wireless client device, in response to the access point receiving a message from a new client device from which it has not previously received a message. If the fat access, point receives a message from a wireless client device that has roamed to the fat access point from another access point and the message includes an IP address of the wireless client device, then the fat access point may send a DHCP discover message to a DHCP server on behalf of the wireless client device On receiving an IP address in a DHCP offer from the DHCP server, the fat access point may determine whether the two IP addresses are the same or not. If they are the same, then the fat access point may allow the wireless client device to access the WLAN and may pass traffic to and from the wireless client device. If the IP addresses are different, then the fat access point may send a force renew DHCP message to the wireless client device, in a similar fashion to that described for the controller in FIGS. 2 and 3. The fat access point may then snoop any resulting DHCP session, or block the wireless client device if it does successfully obtain a new IP address within a predetermined time or number of attempts.

The methods and apparatus described in this disclosure are merely by way of example and various modifications and alterations may be made to the specific examples without departing from the scope of the claims.

All of the features disclosed in this specification (including any accompanying claims, abstract and drawings), including any of the processes in the methods disclosed in the description and diagrams, may be combined in any combination, except combinations where at least some of the features and/or processes are mutually exclusive. Furthermore, while the method diagrams and description depict a certain order for carrying out the blocks and processes, unless logic dictates otherwise the order of certain blocks and processes may be changed, or certain blocks or processes may be carried out contemporaneously, or partially contemporaneously.

Each features disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method comprising:
a controller receiving, via an access point, a message from a wireless client device, the message including an internet protocol (IP) address of the wireless client device;
in response to determining that the controller has not previously received a message from the wireless client device, the controller communicating with a dynamic host configuration protocol (DHCP) server on behalf of the wireless client device; and
in response to determining that an IP address received from the DHCP server is not the same as the IP address included in the message from the wireless client device, the controller sending a DHCP force renew message to the wireless client device, the DHCP force renew message instructing the wireless client device to initiate a DHCP session to obtain a new IP address for the wireless client device.

2. The method of claim 1 wherein the controller communicating with a DHCP server comprises the controller sending a DHCP discover message on behalf of the wireless client and receiving a DHCP offer from a DHCP server in response to the DHCP discover message.

3. The method of claim 1 wherein determining that the controller has not previously received a message from the wireless client device comprises determining whether an identifier of the wireless client device is stored in a memory of the controller.

4. The method of claim 3 comprising determining whether an entry relating to the wireless client device is present in a datapath route cache table of the controller, the datapath table including an identifier of the wireless client device and a field indicating how messages from the wireless client device are to be handled.

5. The method of claim 4 comprising determining whether the entry relating to the wireless client device indicates that the wireless device, has completed a DHCP session.

6. The method of claim 1 comprising in response to determining that the IP address received from the DHCP server is the same as the IP address in the message from the wireless client device, updating a memory of the controller to indicate that the wireless client device has completed a DHCP session.

7. The method of claim 1 comprising in response to determining that the IP address of the DHCP server is the same as the IP address of the wireless client device, the controller broadcasting a gratuitous address resolution protocol (GARP) message including said IP address.

8. The method of claim 1 comprising, if no response to the DHCP force renew message is received from the wireless client device after a predetermined time or number of attempts, the controller blacking listing the wireless client device.

9. The method of claim 1 wherein the controller performs the method of claim 1 in response to the controller determining that it is set to a DHCP enforce mode in which it does not accept wireless client devices with static IP addresses.

10. A controller comprising a processor and machine readable instructions executable by the processor to:
receive a message from a wireless client device via an access point which the controller manages; wherein the message includes a source internet protocol (IP) address of the wireless client device;
check whether the controller has a record of a previous dynamic host configuration protocol (DHCP) transaction for the wireless client device;
if the controller has no record of a previous DHCP transaction for the wireless client device, then send a DHCP discover message on behalf of the wireless client device;
receive a DHCP offer for the wireless client device from a DHCP server, the DHCP offer including an offered IP address;
compare the offered IP address with the source IP address of the wireless client device;
and if the offered IP address and the source IP address of the wireless client device are not the same, then send a DHCP force renew message to the wireless client device so as to cause the wireless client device to initiate a DHCP session to obtain a new IP address.

11. The controller of claim 10 wherein the machine readable instructions include instructions to snoop the DCHP session to obtain the new IP address of the wireless client device and to broadcast the new IP address in a gratuitous address resolution protocol (GARP) message.

12. The controller of claim 10 wherein the machine readable instructions includes instructions to block the wireless client device if the source IP address of the wireless client device is different from the offered IP address and the wireless client device does not successfully obtain a new IP address in response to the DHCP force renew message.

13. The controller of claim 10 wherein the controller includes a memory storing a datapath route cache table and wherein the instructions include instructions to check whether an entry relating to the wireless client device in the datapath route cache table indicates that the wireless client device has completed a DHCP session.

14. The controller of claim 10 wherein the controller has a memory storing a user table and the instructions include instructions to add an entry for the wireless client device to the user table after determining that the offered IP address is the same as the source IP address of the wireless client device.

15. A fat access point comprising a processor and machine readable instructions executable by the processor to:
receive a message from a wireless client device associated with the fat access point, the message including an internet protocol (IP) address of the wireless client device;
determine whether the fat access point has previously received a message from the wireless client device;
if the fat access point has not previously received a message from the wireless client device, then the fat access point communicating with a dynamic host configuration protocol (DHCP) server on behalf of the wireless client device;
the fat access point checking whether an IP address received from the DHCP server is the same as the IP address included in the message from the wireless client device;
if the IP address received from the DHCP server and the IP address including in the message from the wireless client device are not the same, then send a DHCP force renew message to the wireless client device.
